(19) United States
(12) Patent Application Publication
(10) Pub. No.: US 2012/0270198 A1
(43) Pub. Date: Oct. 25, 2012

(54) MECHANICAL EDGE VIDEO APPLICATION AND LEARNING SYSTEM

(76) Inventors: Vincent Joseph Mika, Chicago, IL (US); Mary Carmella Mika, Chicago, IL (US)

(21) Appl. No.: 13/539,795

(22) Filed: Jul. 2, 2012

Related U.S. Application Data
(63) Continuation-in-part of application No. 12/590,734, filed on Nov. 13, 2009, now abandoned.

(51) Int. Cl. G09B 5/00; A63F 9/24

(52) U.S. Cl. 434/308; 273/429; 463/9

(57) ABSTRACT

The system and method of learning technical or scientific content in combination with a video game includes provision of a learning module, provision of a gaming module, execution of actions in each of the learning and gaming modules, and alternating, in response to one or more predetermined learning or gaming conditions, between the learning and gaming modules.

### CROSS-REFERENCE TO RELATED APPLICATIONS

This application is a Continuation-In-Part of U.S. patent application Ser. No. 12/590,734 filed Nov. 13, 2009, pending.

### FIELD OF THE INVENTION

The present invention relates, in general, to learning systems and methods and, more particularly, this invention relates to system and method for learning technical or scientific content in combination with a video game.

### STATEMENT REGARDING FEDERALLY SPONSORED RESEARCH AND DEVELOPMENT

N/A

### REFERENCE TO SEQUENCE LISTING, A TABLE, OR A COMPUTER PROGRAM LISTING COMPACT DISC APPENDIX

N/A

### BACKGROUND OF THE INVENTION

Computerized learning systems and video games are generally well known, however, to the best knowledge of Applicants, an application does not exist where a user can learn technical or scientific content and immediately apply it in a game environment or, vice versa, where the user is tasked with learning technical or scientific content while playing a game in a game environment. Applicants further are not aware where such interactive game and learning tool application exists for children and young adults.

### SUMMARY OF THE INVENTION

The invention provides a videogame application and learning system Mechanical Edge (Top Flight/Raceway Racer/Fighter Boat or other modes of transportation) which serves both as an interactive game and a learning tool. It allows the challenge and fun of a video game yet provides the user with skills based on the learned technical and/or scientific content and associated tests. Rewards and points are based on skill and tests taken. Accompanying collectibles and their description cards allow the game to be shared by others outside of the cyber world and better envisioned and discussed by the players.

OBJECTS OF THE INVENTION

It is, therefore, one of the primary objects of the present invention to provide a method for learning technical or scientific content in combination with a video game.

Another object of the present invention is to provide a method for learning technical or scientific content in combination with a video game that provides learning and gaming modules and requires user to switch between learning gaming modules in order to apply learned technical or scientific content.

Yet another object of the present invention is to provide a method for learning technical or scientific content in combination with a video game that requires user to answer a set of questions.

A further object of the present invention is to provide a method for learning technical or scientific content in combination with a video game that requires user to attain a preselected score prior to resuming actions in the gaming module.

Yet a further object of the present invention is to provide a method for learning technical or scientific content in combination with a video game.

An additional object of the present invention is to provide a method for learning technical or scientific content in combination with a video game wherein the video game includes plurality of game levels.

Another object of the present invention is to provide a method for learning technical or scientific content in combination with a video game implemented by way of a computer or processor.

A further object of the present invention is to provide a method for learning technical or scientific content in combination with a video game wherein sets of technical or scientific information is communicated to the user in at least one of video and audio formats.

Another object of the present invention is to provide a method for learning technical or scientific content in combination with a video game that exposes the user to various mechanical scenarios (different aircraft, boats, etc) in a selected game terrains or landscape.

Yet another object of the present invention is to provide a method for learning technical or scientific content in combination with a video game that allows for a multitude of scientific learning opportunities in mechanics and physics.

A further object of the present invention is to provide a method for learning technical or scientific content in combination with a video game that that includes physical models corresponding to computerized attributes in order to aid in user's learning of technical and/or scientific content.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a block diagram of a system of learning technical or scientific content in combination with a video game;

FIG. 2 is a block diagram of a learning module of the system of FIG. 1;

FIG. 3 is a block diagram of a gaming module of the system of FIG. 1; and

FIG. 4 is a flowchart of a method of learning technical or scientific content in combination with a video game.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

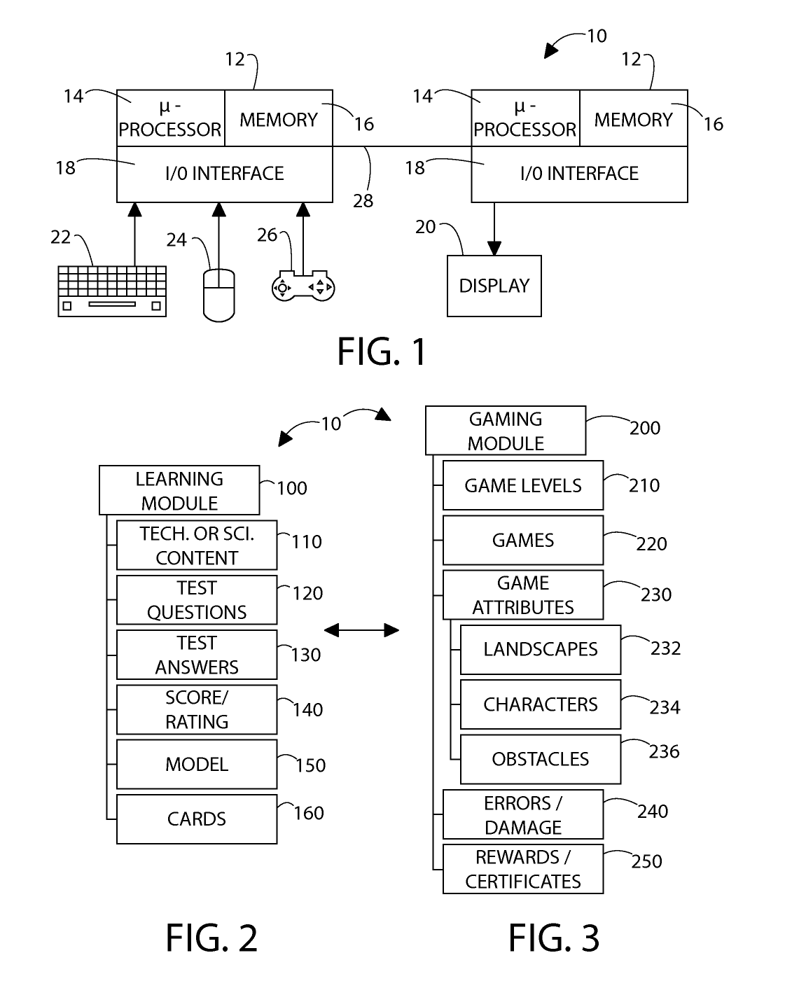

Now in reference to FIGS. 1-4, the instant invention provides a computer-implemented system and method for learning technical or scientific content in combination with a video game. The system 10 of the instant invention is represented by software or computer readable medium that is executed on one or more computers 12, each including a processor 14, a memory or data storage 16, which can be internal, external or both and input/output interface 18. The computer 12 may be of a conventional type including or connectable to a display 20 and further connectable to peripheral input devices such as keyboard 22 and mouse 24. Computer 12 can be also provided as a video game console connectable to the above described display 20 and further connectable to an input device, such as a game controller 26. It is also contemplated that computers 12 could be networked together over the Internet or any other suitable link 28 and that one or more users can access the software or computer readable medium located remotely on a networked computer (not shown). Thus, the system 10 can be used by two or more players situated in the same physical location or in remote locations.

In further reference to FIGS. 2-3, the system 10 includes a learning module 100 and a gaming module 200, which essentially are instructions executed by the processor 14. Modules 100 and 200 are interrelated therebetween enabling incremental and sequential learning of technical (mechanical, electrical, etc) and scientific principles.

The learning module includes technical or scientific content 110 that allows the user to learn aspects what needs to be done in order to properly perform an action within the gaming module. The technical and/or scientific content 110 may include written instructions, diagrams, flowcharts, drawings, figures and any combinations thereof. To assure that the user sufficiently learns technical and/or scientific content 110, the learning module 100 further includes at least one set of test questions 120. Test is to be understood as also meaning an exam or quiz. Each question may require the user to input an answer; be provided with multiple choice answers, requiring the user to choose one or more answers; as a diagram requiring the user to name each component or portion of the diagram; as an essay type question or any combination thereof. The learning module 100 may further include answers 130 to each test question 120 and further explanations with references to the technical and/or scientific content 110. Finally, the processor 14 rates user's answers and determines score/rating 140.

Gaming module 200 includes game levels 210 and games 220, which are preferably provided with a predefined circuit or path. It is contemplated to provide one or more games 220 for each of the plurality of game levels 210. Each game 220 is adapted with game attributes 230 including but not limited to game landscapes 232, game characters 234 and game obstacles 236 associated with each game landscape 232. Game landscape 232 may include but not limited to urban environment with buildings and other stationary objects or structures, natural terrains, such as desert, sea, jungle, forest, mountain, weather condition and the like, cosmos including planets, black holes, warm holes, nebulas and the like and any combination thereof. By way of an example only, game character 234 may be any mode of transportation including but not limited to an airplane, automobile, ship, space ship; animals, science fiction characters, people, weapons and the like. Game characters 234 can be given active or disabled status depending on the gaming conditions. By way of examples only, game obstacles 236 may be defined as buildings, structures, mountains, reefs, trees and other vegetation, weapons, bodies of water, animals, fictional characters or figures and other moving characters. The instant invention exposes the user to various mechanical scenarios (different aircraft, boats, etc) in a selected game terrains or landscape 232. This selection of Game Attributes within a game environment allows for a multitude of scientific learning opportunities in mechanics and physics.

The essential steps of the method include providing a learning module, providing a gaming module, executing actions in each of the learning and gaming modules, and alternating, in response to one or more predetermined learning or gaming conditions, between the learning and gaming modules.

The step of providing the learning module 100 includes the step of providing technical and/or scientific content 110 that allows the user to learn aspects of what needs to be done in order to properly perform an action within the gaming module 200. The technical and/or scientific content 110 may include written instructions, audio instructions, diagrams, flowcharts, drawings, figures and any combinations thereof. In addition to the technical and/or scientific content 110 being displayed on the display 20 it is also contemplated to provide such technical and/or scientific content 110 in an audio format that can be advantageous for younger users not yet mastered reading skills. To assure that the user sufficiently learns technical and/or scientific content 110, the step of providing the learning module 100 includes the step of providing at least one set of test questions 120. It is contemplated that the test questions can be displayed on the display 20, provided in an audio format or both. After the user answers the set of test questions 120, the user's answers are rated by the processor 14 and the results are communicated to the user, for example, by way of displaying the score on the display 20. Processor 14 also executes a set of instructions that compares the score against a predetermined learning threshold for a particular set of test questions 120 and provide the user with rating 140 and/or a pass or fail criteria. Preferably, the user that answers less than predetermined number of questions and thus fails to receive sufficient score is directed to first relearn the technical and/or scientific content 110 and then retake the test by answering the same or different set of questions 120. The user receiving sufficient score to pass the test is allowed to proceed (or switch from the learning module 100) to the gaming module 200 and advance to the next game 220 within the same level 210 or advance to a higher level 210. Processor 14 executes additional instructions that track user's access to a particular game 220 or level 210. However, it is contemplated to advance the user failed to receive sufficient score or rating 140 either after the first test or any subsequent test, which may be advantageous for younger users.

It is to be also understood, that the test questions 120 are displayed on the display 20 and the user uses at least one of keyboard 22, mouse 24 or the game controller 26 in order to input user's answers. It is to be also understood that test answers 130 and score/rating 140 is also displayable on the display 20.

The step of executing actions in the gaming module 200 includes the step of providing a plurality of game levels 210. It is contemplated to incrementally and sequentially increase difficulty of each subsequent game level 210. The step of executing actions in the gaming module 200 further includes the step of providing one or more game 220 for each of the plurality of game levels 210.

In the gaming module 200, the user using at least one of keyboard 22, mouse 24 or the game controller 26 moves one or more game characters 234 through one or more game obstacles 236. The method also includes the step of displaying, on the display 20, one or more game landscapes 232, one or more game obstacles 236 and movement of one or more game characters 234 in the one or more game landscapes 232 through the one or more game obstacles 236. By way of one example only, in combination with a racing game employing airplane as a character 232, the relationship between game levels 210, games 220, characters 234 and obstacles 236 are shown in Table 1.

In each game 220, the processor 14 executes instructions that provide the user with errors or damages 240 that are displayed on the display 20. These errors or damages 240 are than correlated to technical or scientific content 110. By way of one example only of level 1 in table 1, when the airplane 232 is damaged by other airplanes, the processor 14 executes a set of instructions that display on the display 20 the portions/parts of the airplane 232 that are affected by such damage. Accordingly, the user is directed to a specific technical or scientific content 110 that is related to the displayed damages.

TABLE 1

| | No of | | | | |
|---|---|---|---|---|---|
| | Games | Characters | Error/ | Technical or | |
| | per | and | Damage | Scientific | Skills |
| Level | Level | Obstacles | Display | Content | Attained |
| 1 | 3 | Other | Control | How Wiring is | Speed |
| | | airplanes | Panel | connected from | |
| | | | (altitude, | Control Panel | |
| | | | pressure, | throughout | |
| | | | etc) | plane | |
| 2 | 5 | Mountains, | Wings get | Aerodynamics | Agility |
| | | other | damaged | | |
| | | airplanes | | | |
| 3 | 7 | Lava | Steering | How Steering | How to |
| | | Shooting | Mechanism | Mechanism | use the |
| | | from | Damaged | Works | Steering/ |
| | | Volcanoes | | | Control |
| | | | | | Panel to |
| | | | | | Navigate |
| | | | | | Plane |
| 4 | 9 | Monsters | Fuel Tank | How Fuel Tank | How to |
| | | throwing | Damaged | is connected | control |
| | | rocks | | and | Fuel |
| | | and Lava | | controlled; | to go |
| | | Shooting | | temperature | faster/ |
| | | from | | control | slower |
| | | Volcanoes | | | |
| 5 | 11 | Huge | Engine | How Engine | How to go |
| | | Dinosaurs | Damaged | works/How | faster |
| | | that can | | Fuel is burned | |
| | | jump up | | | |
| | | and bite | | | |
| | | a plane | | | |
| | | and Lava | | | |
| | | Shooting | | | |
| | | from | | | |
| | | Volcanoes | | | |
| 6 | 13 | Tropical | Entire | Weather | All Skills |
| | | Storm, | Plane goes | Conditions/ | from all |
| | | Meteors, | down/Gets | How to | Passed |
| | | and Huge | eaten | navigate in | Levels |
| | | Dinosaurs | | high winds/ | |
| | | that can | | rain | |
| | | jump up | | | |
| | | and bite | | | |
| | | a plane | | | |

The instant invention anticipates that the user can begin either in the learning module 100 or in the gaming module 200 and provides gaming or learning conditions that force the user to alternate between the modules, particularly if the user begins in the gaming module 200 so that the user is required to read set of technical or scientific content 110 and answer the set of test questions 120. Equally as important, the instant invention provides the step of switching from the gaming module 200 to the learning module 100 when a user fails to complete a predetermined number of games 220, complete a game 220 within predetermined period of time, earn a predetermined number of points in any one game 220 or avoid one or more obstacles 236 in any one game.

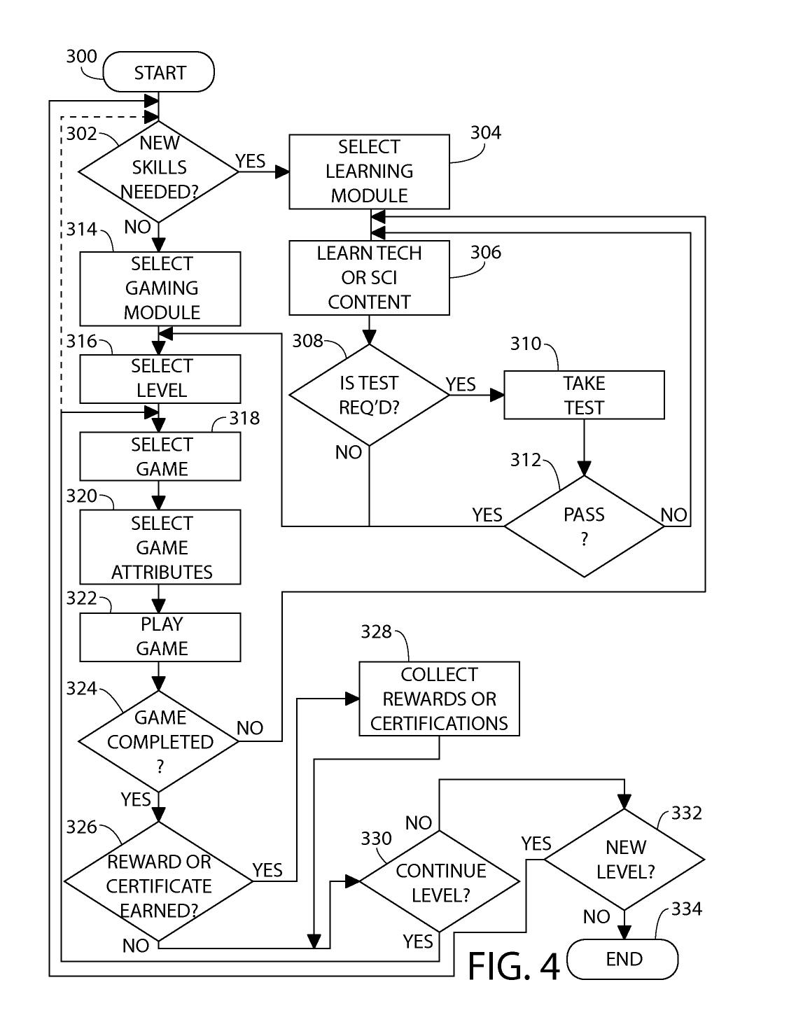

Now in a particular reference to the flowchart of FIG. 4, the method commences at the start step 300 where the user accesses the computer 10. Essentially, the user makes a decision at step 302 as to whether the user needs to learn new skills prior to proceeding to the gaming module 200. If the user needs to obtain new skills, the user selects the learning module 100 in step 304 and proceeds with learning technical or scientific content 110 in step 306. The user than selects to take test in step 308 and takes the test in step 210. However, it is also contemplated that the user may decide to skip steps 306 and 308 and directly proceed to step 310.

The user failing to pass the test in step 312 is preferably directed back to step 306 in order to re-learn technical or scientific content 110 and subsequently retake the test at step 310. The user passing the test in step 312 is allowed to proceed to the gaming module 200, where the user selects level in step 310. It is important to note that the processor 14 executes another set of instructions that track actions in each of modules 100 and 200, so that the user attempting to select a specific game level 210 when the user did not learn the appropriate technical or scientific content 110 may not be permitted to do so and will be prompted to go back to step 306.

If the user decides that no new skills are needed in step 302, the user proceeds directly to selecting gaming module 200 in step 314. After selecting the gaming module 200 in step 314, the user selects a game 220 in step 318 and may further select attributes 230 in step 320, although it is contemplated that the selected game 220 may be provided with preselected attributes 230 that cannot be changed/replaced by the user.

The step 322 of playing the selected game 220 includes the step of applying the skills obtained in the learning module 110 but, otherwise, is achieved in accordance with conventional game playing techniques. If the user completes the game 220 in step 324 in accordance with predefined conditions, the user may earn an award, certificate or badge 250 to be collected in step 328 and allowed to decide in step 330 to select another game 220 at the same level 210 or to select another level 210 in step 332. The awards or certificates 250 can be accrued after completing a predetermined number of games 220 and/or game levels 210 or the user may decide to immediately redeem rewards or certificates 250 to obtain or unlock new characters 234 or obstacles 236 or repair and/or reactivate a disabled character 234. The rewards may be also represented by currency with which the user may purchase new characters 234. It must be noted that a predetermined amount of currency can be provided prior to playing the game 220 in step 322, for example for medicine or initial repairs. If the user does not complete the game 220 in step 324 in accordance with a predefined gaming conditions, for example such as earning less than predetermined number of game points, the user is directed back to step 306 in order to re-learn technical or scientific content 110 and subsequently and preferably to retake the test at step 310. For example, the user who learned how execute a take-off procedure with an airplane 234 in step 306 and failing to properly execute such take-off procedure in step 322, will be required to re-learn the procedure again. Furthermore, the failure to execute such take-off procedure generally results in a crash. The processor 14 then executes instructions that determine damages and placement of such damages to the airplane 234, visually identify such damages to the user on the display 20 and correlate the damages with a set of specific technical and/or scientific content 110 related to proper take-off procedure so as to avoid at least a particular crash mode. The processor 14 may be also configured to execute instructions by which the user is prompted during playing a particular game 220 in step 322 to the correlating technical and/or scientific content 110.

The step 322 may also include the step of finding clues in the gaming module 210 after learning technical or scientific content in the learning module 100. In the above example, if the airplane 234 is equipped with a nose propeller (not shown) that is damaged during the crash, the user may be prompted or may elect to perform what is conventionally known as a scavenger hunt to find a new propeller. In such instance, the processor 14 executes a set of instructions that provide clues to the user as to where and/or how to find such new propeller. The clues may also lead the user to find tools that will be needed to replace the propeller based on the instructions learned in step 306. Or the clues may lead the user to find medicine so as to treat the pilot injured during the crash, again in accordance with a predefined technical or scientific content 110.

The instant invention also contemplates that the system 10 includes at least one accompanying physical model 150 that is preferably provided in combination with a learning module 100 and which is so configured as to correlate to a predetermined character 234 and provide the user with an additional learning tool. For example, when such predetermined character 234 is the airplane 234, the model 150 will be constructed in a preselected scale relationship to incorporate all features of the airplane 234 and may further include detachable features, for example such as engines, boosters, gliders, wings, tail, controls, wheels and the like. Each feature of the model 150, being for example an airplane, is referenced, by alpha and/or numeric characters, and corresponds to the alpha and/or numeric characters in the written and graphic technical content 110. Thus, younger user, for example of ages six to nine years, may use such model 150 when learning technical or scientific content 110 in step 306 or answering set of test questions 120 in step 310. By way of one example only, the test questions 120 may be provided as a diagram with outlines representing the exact features on the model 150, wherein the user must correctly identify the outlines aided by the model 150. The model 150 may be also of a collectable type.

The system 10 may also include cards 160 or other printed item or article, even of a collectable quality, that describe characteristics of each character 234 in combination with such characteristics contained within the set of technical or scientific content 110. The rewards 250, represented by currency, can be used to purchase new models 150 or cards 160. The at least one physical model 150 or at least one printed item 160 is configured in direct relationship to each of a preselected attribute in the gaming module 200 and content 110 in the learning module 100.

The invention also contemplates different user classifications in combination with certain characters 234. For example, in combination with above described airplane, the classification may include such sub-classes as a trainee, repairman, pilot and instructor. In each sub-class the user is allowed to perform predetermined actions within the gaming module 200. By way of one example only, the user selecting an airplane may be first assigned a status of trainee requiring the user to learn predetermined technical and/or scientific content 110 and attain skills, for example shown in Table 1 above, by completing predetermined number of games 220 and/or levels 210 before being advanced into the pilot sub-class.

It is further contemplated for the user to start playing the game 220 in a repairman sub-class and advance by learning how to repair mode difficult features of the airplane 234. The user being such “repairman” can focus only on “how to repair” technical content 110 and associated gaming aspects without the need to know “how to fly” the airplane 234 or may take “flying lessons” by learning associated technical content 110 and become a “pilot”. It would be understood that each sub-class will have a unique description within the learning module 100 and a unique representation within the gaming module 200. The processor 14 may execute instructions to generate and display a virtual model and place the user within such virtual model. By way of one example only, the user attempting to repair an airplane will be “placed” within such engine and will have to travel through and explore the internal structure of the engine so as to identify failures. The internal structure will correspond to a specific technical content 110. A tool set may be also generated by the processor 14 where the user can select a specific tool in order to repair the found failure.

It is further contemplated that the user can by or unlock a new airplane 234 with available rewards rather than repairing the damaged airplane 234 that will be assigned a “disabled” status by the processor 14. The “disabled” status will remain until the user will repair such damaged airplane 234. In other words, the user who qualified as a “pilot” can remain in the game by obtaining a new airplane and must also qualify as a “repairman”, by learning associated technical content 110, in order to repair the disabled airplane 234 so that the processor 14 can assign it an “active” status.

The user can also earn rewards or certificates by learning additional skills and attaining additional sub-classes.

It will be understood that the instant invention is advantageous in providing a learning environment wherein the user instantaneously reinforces learned technical and/or scientific content in a gaming environment, wherein attributes and conditions are simulated and correlated to specific technical and/or scientific content and wherein the user must learn appropriate technical and/or scientific content in order to complete games and game levels.

The instant invention promotes easy access to scientific (mechanical and physical) terms and concepts not readily available to the age group of seven (7) years and up in a fun, non-intimidating and self-paced method.

The instant invention further insures social aspects for a rounded learning experience by including associated collectible models, such as planes, cars, boats and cards with description of models and characters and further promotes tactile reinforcement of mechanics by providing such models as airplane, boat, car parts.

The instant invention also provides an opportunity for remotely located players that expand the possibilities for competition, planning, learning, and skill attainment.

Mechanical Edge Application is a video game and learning program. Identity in the video game comes with a model with interchangeable parts and an activation code. In order to advance in the video game, actual mechanical/technical lessons have to be learned and passed. These mechanical science lessons would include knowing actual plane components/systems (boat, car) and physics behind their function. Other lessons included upgrading your characters status by a repairman learning to be a pilot by taking simulated flight lessons. Therefore, the “front end” end of the game is an exciting video game, but continuation and increased scoring and winning opportunities is based on technical science lessons of the components and mechanics of a vehicle such as an aircraft boat or car.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

We claim:

1. A computer-implemented method comprising:
(a) providing a learning module;
(b) providing a gaming module;
(c) executing actions in each of said learning and gaming modules; and
(d) alternating, in response to one or more predetermined learning or gaming conditions, between said learning and gaming modules.

2. The computer-implemented method of claim 1, wherein the step (a) includes the step of providing technical or scientific content.

3. The computer-implemented method of claim 1, wherein the step (a) includes the step of providing at least one set of test questions.

4. The computer-implemented method of claim 3, wherein the step (a) includes the step of rating answers to said at least one set of test questions.

5. The computer-implemented method of claim 1, wherein the step (a) includes the step of at least one of incrementally and sequentially providing technical or scientific content.

6. The computer-implemented method of claim 1, wherein the step (b) includes at least one of the step of providing a plurality of game levels, the step of providing one or more games for each of said plurality of game levels, the step of providing one or more game landscapes, one or more game characters and one or more game obstacles for each of said plurality of game levels.

7. The computer-implemented method of claim 5, wherein the step (b) includes the step of at least one of incrementally and sequentially increasing difficulty of said each of said plurality of game levels in direct relationship to technical or scientific content.

8. The computer-implemented method of claim 1, wherein the step (c) includes the step of moving, with an input device, one or more game characters through one or more game obstacles.

9. The computer-implemented method of claim 1, wherein the step (c) includes the step of displaying, on a display, one or more game landscapes, one or more game obstacles and movement of one or more game characters in said one or more game landscapes through said one or more game obstacles.

10. The computer-implemented method of claim 1, wherein the step (c) includes at least one of the step of reading or listening to, by a user, a set of technical or scientific content, the step of answering, by a user, a set of test questions, the step of rating, by a processor, answers to said set of test questions, and the step of using skills learned by a user in said learning module to advance within a game level or between game levels in said gaming module.

11. The computer-implemented method of claim 10, further including the step of advancing said user correctly answering a predetermined number of questions from said set of test questions.

12. The computer-implemented method of claim 1, further including the step of at least one of earning and accruing, by a user, rewards in at least one of said gaming and learning modules.

13. The computer-implemented method of claim 1, wherein the step (d) includes the step of switching from said learning module to said gaming module, when a user correctly answers a predetermined number of questions.

14. The computer-implemented method of claim 13, wherein the step (d) includes the step of relearning technical or scientific content when said user correctly answers less than said predetermined number of questions.

15. The computer-implemented method of claim 1, wherein the step (d) includes the step of switching from said gaming module to said learning module, when a user fails at least one of completing a predetermined number of games, completing one game in a predetermined period of time, earning a predetermined number of points in any one game, and avoiding one or more obstacles in any one game.

16. The computer-implemented method of claim 1, wherein the step (d) includes the step of providing prompts during performing actions in said gaming module in step (c) and the step of correlating said prompts to a predetermined technical or scientific content in said learning module.

17. The computer-implemented method of claim 1, wherein the step (d) includes the step of finding clues in said gaming module after learning technical or scientific content in said learning module.

18. A system comprising:
(a) one or more processors or computers; and
(b) one or more memories containing program content executable by said one of more processors or computers, said program content comprising:
i. executable content that allow user to learn technical or scientific content,
ii. executable content that allow said user to apply said learned technical or scientific content in a gaming environment, and
iii. executable content that cause said user to switch from a gaming environment to a learning environment when application of said learned technical or scientific content in said gaming environment fails to meet one or more predetermined requirements.

19. The system of claim 18, further including one or more displays configured to display said technical or scientific content and attributes of said gaming environment.

20. The system of claim 18, wherein said one of more processors or computers is at least a pair of said processors or computers and wherein said system further includes a link between said at least pair of said processors or computers.

21. The system of claim 18, wherein said gaming environment includes a plurality of selectable game attributes configured to represent plurality of technical and scientific principles, contained within said learning module, through motion or play.

22. The system of claim 18, further including at least one of at least one physical model and at least one printed item configured in direct relationship to each of a preselected attribute in said gaming module and content in said learning module.

23. A computer readable storage medium containing program content executable by a processor, said program content comprising:
(a) executable instructions that allow user to learn technical or scientific content;
(b) executable instructions that allow said user to apply said learned technical or scientific content in a gaming environment; and
(c) executable instructions that cause said user to switch from a gaming environment to a learning environment when application of said learned technical or scientific content in said gaming environment fails to meet one or more predetermined requirements.
